(19) United States
(12) Patent Application Publication
(10) Pub. No.: US 2022/0202233 A1
(43) Pub. Date: Jun. 30, 2022

(54) FOOD DISPENSING DEVICE

(71) Applicant: Serenete Corporation, Lawrenceville, GA (US)

(72) Inventors: Jesse Austin Rosalia, Atlanta, GA (US); Haidee Chen, Lawrenceville, GA (US)

(21) Appl. No.: 17/497,808

(22) Filed: Oct. 8, 2021

Related U.S. Application Data
(63) Continuation of application No. 14/744,022, filed on Jun. 18, 2015, now abandoned.
(60) Provisional application No. 62/013,843, filed on Jun. 18, 2014.

(51) Int. Cl. A47J 31/52

(52) U.S. Cl. CPC A47J 31/52; A47J 31/525

(57) ABSTRACT

A food dispensing device or system which dispenses food extracted from pre-packaged food containers is described. One or more food extraction mechanisms retrieve food from storage containers. The food can be packaged and dispensed to a user for subsequent preparation.

### RELATED APPLICATIONS

This application is a continuation of U.S. patent application Ser. No. 14/744,022, filed Jun. 18, 2015; which claims benefit of priority to U.S. Provisional Patent Application No. 62/013,843, filed Jun. 18, 2014; the aforementioned priority applications being hereby incorporated by reference in their respective entireties.

### TECHNICAL FIELD

The disclosed embodiments relate generally to a food dispensing device.

### BACKGROUND

Currently there exist machines which store and dispense containers of food in return for payment.

There also exist mechanisms to access the contents of food containers.

### BRIEF DESCRIPTION OF THE DRAWINGS

FIG. 1 illustrates a device to package food ingredients, according to an embodiment.

FIG. 2 illustrates a system to dispense and package food ingredients from containers, according to an embodiment.

FIG. 3A illustrates an extraction mechanism to tip a food container, in an embodiment.

FIG. 3B illustrates an extraction mechanism to measure an amount of food, according to an embodiment.

FIG. 3C illustrates an extraction mechanism to selectively retrieve food ingredients from a container, according to an embodiment.

FIG. 3D illustrates an extraction mechanism to move food from a container via an outlet, according to an embodiment.

FIG. 4 illustrates a method of dispensing food from containers, in an embodiment.

### DETAILED DESCRIPTION

Embodiments described herein provide for a food ingredient packaging apparatus to dispense food from containers stored within a housing or structure. As described with numerous examples, the apparatus can provide bulk food ingredients in bins for selection by users. In some examples, the apparatus can include robotic mechanisms and automated mechanical components which service to extract selected ingredients and amounts, and then packages the food ingredients into a tray for the user. The tray can be configured for use with, for example, an automated food preparation device such as described by U.S. patent application Ser. Nos. 14/171,578 and 14/171,539; both of the aforementioned applications being hereby incorporated by reference in their respective entirety.

According to some embodiments, a tray can be packaged in a manner that is optimized or suited for a food preparation device.

In some examples, a food ingredient packaging apparatus includes an input interface to receive selection input that identifies one or more food ingredients, a plurality of compartments, each compartment positioned to hold a corresponding bulk food container, and each bulk food container holding a corresponding food ingredient. The apparatus further includes one or more food extraction mechanisms which are moveable to interface with the corresponding bulk food containers of each of the plurality of compartments. A controller of the apparatus processes the selection input from the input interface in order to identify one or more bulk food containers which hold the one or more identified food ingredients, and controls at least one food extraction mechanism to extract the identified one or more food ingredients from the corresponding one or more bulk food containers held in one or more of the plurality of compartments which are identified by the selection input. The apparatus further includes a receptacle mechanism. The at least one food extraction mechanism and the receptacle mechanism combine to collect the extracted one or more food ingredients into a single tray.

In an embodiment, a food ingredient packaging apparatus stores bulk food containers of ingredients for meals. A controller of the apparatus utilizes mechanically controlled devices to physically interact with the containers and/or their contents, to extract the contents. The apparatus then provides the ingredients in a post-packaged form.

Some embodiments described herein provide for a food ingredient packaging apparatus which includes one or more food extraction mechanisms to remove individual food components from containers. In such embodiments, the apparatus can receive one or more selections for food ingredients from a user and utilizes the food extraction mechanisms to provide the selected ingredients. The selections can be made locally through direct interface with the apparatus, wirelessly through operation of a mobile device, and/or over a network (e.g., remotely).

In an aspect, an apparatus such as described can hard and soft shelled containers of food. The containers are positioned within compartments in the device so that the foods can be extracted for a user.

In another aspect, an apparatus such as described can receive input in the form of a recipe for a dish or meal, and from the recipe, food ingredients (ingredients). For example, an apparatus can wirelessly receive a request over the Internet which includes a recipe from a user operating a computing device. In such an example, the apparatus retrieves food from containers corresponding to the recipe and dispenses the food ingredients to the user.

Examples as described below can be provided in a variety of environments, such as grocery store, market, convenience store, farmer's market, airport, shopping mall, street corner, etc. An apparatus such as described can be made in a variety of sizes.

One or more embodiments described herein can provide for methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines. A programmatic module can also be initiated or executed remotely via the Internet.

Furthermore, one or more embodiments described herein may be implemented through instructions that are executable by one or more processors. These instructions may be carried on a computer-readable medium.

Food Ingredient Packaging Apparatus

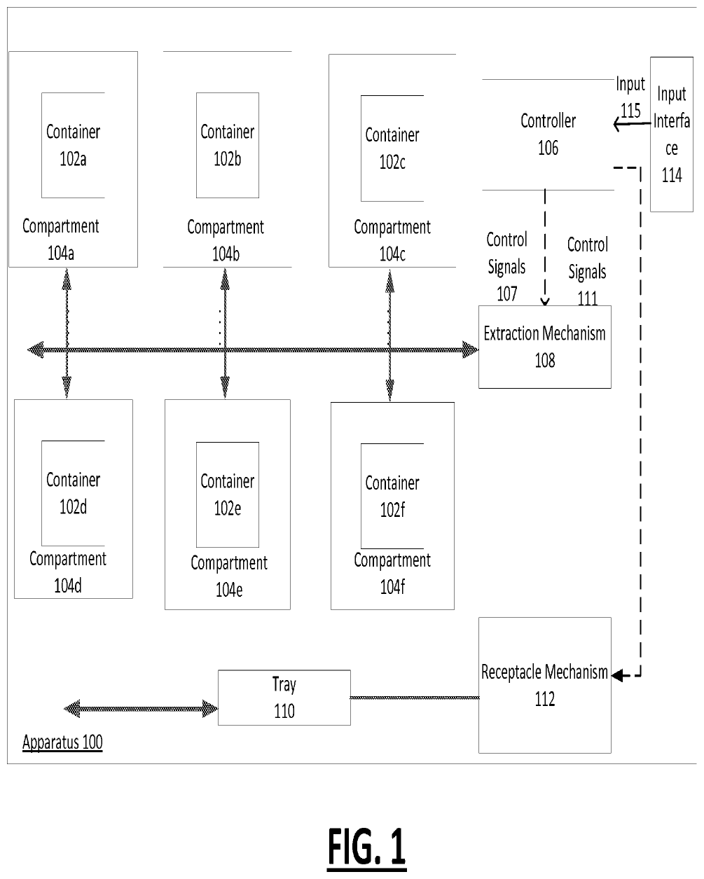

FIG. 1 illustrates an apparatus to package food ingredients, according to an embodiment. More specifically, an apparatus 100 of FIG. 1 operates to store food ingredients in bin containers, respond to input by selecting and extracting food ingredients and amounts from the bins, and dispenses the food ingredients as a packaged tray to a user. The tray can be structured for use with a food preparation system. In some embodiments, the apparatus 100 is a vending machine, or alternatively a self-serve machine, which can be operated by a user who is in proximity or remote.

According to an embodiment, the apparatus 100 includes a housing structure 105 which includes a plurality of compartments 104 for holding a number of food containers 102. The apparatus can also include one or more extraction mechanisms 108, a receptacle mechanism 112, and a controller 106. The containers 102 can store bulk food ingredients, meaning raw or cooked food that can be selected by amount. The bulk food ingredients can be unpackaged, packaged until requested by the user, or packaged when deposited with other items in a receptacle for the user.

In an implementation of FIG. 1, the housing 105 can create a refrigerated environment for storing food items. Other environmental conditions, such as vacuums or chilled/frozen conditions can also be created, either for specific compartments 104 or for the apparatus as a whole. In variations, each compartment 104 can be controlled to an environment that is suited or optimized for a type of food item. As described in greater detail, the housing 105 can retain automated and/or robotic components (e.g., extraction mechanism 108 and receptacle mechanism 112), which combine to extract and dispense food from containers 102 in packaged receptacles. Food is dispensed into a tray and provided to the user.

With further reference to FIG. 1, the apparatus 100 includes food containers 102a, 102b . . . 102g (collectively “102”) within corresponding compartments 104a, 104b . . . 104g (collectively “104”). The apparatus 100 includes a controller 106 which receives input 115 provided by a user through an input interface 114, such as from a user in proximity or remote (e.g., over a network). In one implementation, the input interface 114 includes a touchscreen, button set or other input mechanisms for receiving direct user input. In variations, the input interface 114 can include a local wireless link for communicating with a mobile computing device of a user (e.g., via Bluetooth). In other variations, the input interface 114 includes a cellular or Ethernet link to receive input from the user over a network. The input 115 requests one or more food items for dispensation. To fulfill the request, controller 106 provides control signals 107 to extraction mechanism 108 to move food from containers 102 into a tray 110. Once the food has been moved, controller 106 provides control signals 111 to receptacle mechanism 112 to dispense tray 110 to a user. The input 115 specified by the user can also include various forms, including direct input which specifies a particular food ingredient, recipe input which identifies a recipe from which food ingredients can be programmatically determined, and/or indirect input which identifies food by type or characteristic (e.g., “hot sauce”).

The controller 106 can include one or more processors or processing resources, including integrated circuits, firmware or software. In some implementations, the controller 106 can include specialized processing resources (e.g., hardware, firmware) for robotic control and applications. The controller 106 operates to control the extraction mechanism 108 to extract food ingredients from individual containers of food. The controller 106 can respond to input 115 by implementing processes to identify which containers include food ingredients of the user specification. In some implementations, the controller 106 can include a preliminary step of ingredient identification, recipe analysis (e.g., to identify ingredients) or ingredient substitution. Accordingly, the controller 106 can include software and memory to hold information and instructions for making such determinations.

In operation, the controller 106 can operate to identify individual compartments 104 where bulk food containers 102 are stored with the food ingredients identified from the user input. The controller 106 can also include or access an address data structure 109 which maps each compartment 104 to a particular container 102. The position (e.g., coordinates) of each container 102/compartment 104 can be stored and used by the controller 106 in order to generate control signals 107 for controlling the food extraction mechanism(s) 108. The controller 106 provides the control signals 107 to the extraction mechanism 108 in order to control selection of compartment 104/container 102 and amount of food to extract the identified food ingredients from the corresponding bulk food containers. The one or more food extraction mechanisms are moveable to interface with the bulk food containers 102a, 102b . . . 102g and/or their contents, in order to collect the contents. The one or more food extraction mechanisms combine with a receptacle mechanism 112 to collect the extracted food ingredients into a single tray (tray 110). Tray 110 can be physically provided to the user at the location of the apparatus 100.

Among other advantages, apparatus 100 enables users to obtain individual packaged food ingredients. In this way, apparatus 100 provides users with convenient access to individual food ingredients. Furthermore, users of apparatus 100 may automatically provide payment in return for food ingredients, without requiring the presence of a human recipient.

The food extraction mechanism 108 can be implemented in a variety of ways. According to some embodiments, the food extraction mechanism 108 is distributed electro-mechanical components which are individually provided with the compartments 104 to enable extraction of food items by controlled amount. In variations, the food extraction mechanism 108 is a robotic element (or set of elements) which operates in two or three dimensions to pick food from bins of the compartments 104.

Accordingly, in some embodiments, the food extraction mechanism 108 can include a set of mechanically controlled devices which physically interact with individual food ingredients and/or with their corresponding food containers to cause extraction of the food ingredients from the corresponding bulk food containers 102. For example food extraction mechanisms may interface with food ingredients and/or their corresponding containers by weighing, pushing, pulling, directing, lifting, dropping, or measuring ingredients and/corresponding containers. Furthermore food extraction mechanisms described herein include mechanisms which unseal, open, or cut food containers.

In alternative variations, the food extraction mechanism 108 can include valves which control size of an outlet provided with individual containers 102. The containers 102 can each include openings which are directed downward to cause a gravity driven extraction when a corresponding valve is sufficiently opened. The extraction mechanism 108 can correspond to a valve control mechanism which varies the size of the opening from which food is extracted. In this way, the extraction mechanism 108 may utilize gravity as a driving force.

Extraction mechanism 108 may be individually adapted to retrieve contents from a specific type of containers. In embodiments utilizing multiple extraction mechanisms 108, controller 106 may include logic, such as described below, which is configured to utilize specific extraction mechanisms based on various factors. For example an extraction mechanism may be particularly configured to retrieve a kind of food content held by a container. In an embodiment, apparatus 100 includes a first mechanism to remove solid food, and a second mechanism to remove liquid food.

The logic of controller 106 can be implemented by, for example, a processor executing stored instructions, a logical module, software, hardware, firmware, integrated circuits and/or programming to control operations of components. In the example of FIG. 1, control signals 107 are provided to extraction mechanism 108, and control signals 111 are provided to receptacle mechanism 112, for operation of the corresponding components.

In another example, extraction mechanism 108 is particularly configured to extract food from particular types of containers (e.g., hard-shelled or soft-shelled containers). Furthermore the components of FIG. 1 may, in implementations, utilize other components (e.g., incision mechanisms) of apparatus 100.

In implementations, containers 102 may have various types, and controller 106 includes logic to provide control signals 107 for extraction mechanism 108 which are based on the type of container. For example, containers may be hard-shelled (e.g., stiff-walled) or soft-shelled (e.g., a flexible bag). Furthermore, controller 106 may classify a container based on the type of food ingredient within the container. For example, raw food such as nuts or meats can have dedicated food extraction mechanisms to void contamination. In an example as in FIG. 1, controller 106 includes logic to retrieve and dispense food ingredients of any kind of container, as well as to select and utilize extraction mechanisms 108 within apparatus 100 which are suited to retrieve food ingredients from those containers.

In an embodiment, an individual bulk food container may include a bag that holds a food ingredient against gravity. To remove the food ingredient, controller 106 utilizes an extraction mechanism 108 to control an outlet of the bag to control a quantity of the food item that is extracted through gravity

Apparatus 100 may contain containers of a single type, or a mixture of multiple types. Furthermore, in embodiments, a single compartment may hold a single type of container, or multiple types. Controller 106 may utilize extraction mechanism 108 to retrieve specific kinds of containers based on the input 115.

In the illustration of FIG. 1, apparatus 100 dispenses food ingredients from containers 102a, 102b . . . 102 in response to input 115. Input 115 includes a request for dispensation of specific food ingredients within the containers 102a, 102b . . . 102. Controller 106 may recognize and select food ingredients for dispensation based on numerous factors from input 115. For example food ingredients may be selectively dispensed based on the quantity, type, size, length, age, or freshness of food. Foods are selected and retrieved based on input 115, and then delivered.

Controller 106 includes functionality to receive and interpret selections for food ingredients from a user. The controller may receive requests over numerous kinds of interfaces. For example these requests may be received remotely (e.g., via an interface for wireless communication), or from physical interfaces forming part of the device (e.g., via a keypad on the device). In an embodiment, the input corresponds to a manual input received from a user.

In an embodiment, controller 106 retrieves a wireless request from a website, and fulfills the order. In another embodiment, controller 106 receives a wireless request from a user directly, and fulfills the order.

In embodiments, controller 106 identifies information which provides further detail about the one or more food ingredients to be extracted. For example, controller 106 may be configured to identify, from input 115, an amount (e.g., by volume or weight) for some or all of the one or more identified food ingredients. The controller 106 controls the one or more food extraction mechanisms to extract the amount of each of the one or more food ingredients from the corresponding bulk food containers. In implementations, the food extraction mechanisms may include a weighing mechanism (e.g., a scale), which controller 106 controls to extract only a predetermined amount of food from a particular bulk food container in accordance with the amount input.

In embodiments, input 115 includes payment by a user in return for the food dispensed from containers 102, 102b . . . 102g. Controller 106 may include logic to recognize that proper payment has been made and apparatus 100 includes features to accept payment. Such features include, by way of example, sensors to recognize physical currency or credit cards.

In examples, containers 102a, 102b . . . 102g hold ingredients for recipes. As described further below with respect to FIG. 1 and other figures, input 115 may include a recipe. Apparatus 100 retrieves the ingredients of the recipe and performs food preparation as needed.

In embodiments of apparatus 100, extraction mechanism 108 is also configured to utilize other mechanisms within apparatus 100. These mechanisms may or may not be formed as part of the extraction mechanism 108. In an example, controller 106 causes extraction mechanism 108 to utilize an incision device which opens a specific container 102. In another example, extraction mechanism 108 is coupled to a weighing mechanism (such as a scale) utilized to identify the weight of dispensed food.

In an embodiment, the containers may be positioned to move via rotation. For example, the compartments 104 (and thus the containers 102) can be positioned on a rotating carousel which can be moved under control of controller 106. For example, the controller 106 issues commands to the carousel which move the containers to close proximity of extraction mechanism 108 for food extraction.

In examples, tray 110 can be provided by the user or the apparatus. The tray 110 can be formed from, for example, plastic, bioplastics, paper or Styrofoam. The tray 110 can be reusable or can be new. The tray 110 can be dimensioned for manipulation by the receptacle mechanism 112, including for movement and/or sealing. The receptacle mechanism 112 includes features to keep food ingredients within tray 110 during food extraction, and during food dispensation. For example, receptacle mechanism 112 may include a feature to wrap food with a covering. In another example, receptacle mechanism 112 may seal the tray when the food ingredients of a user input are collected.

The food ingredient of each individual bulk food container may vary from container to container. For example, the food ingredient of a specific bulk food container may be selected from a group consisting of uncooked or undercooked meat, vegetables, fruit, spices, grains, and manipulated raw foods. To prepare uncooked or undercooked food, apparatus 100 may include prepare the food ingredients for consumption or other use.

In an example, the food ingredients retained in the bulk food containers may be a variety of raw, partially cooked, or cooked ingredients. Apparatus 100 may include one or more cooking mechanisms to at least partially cook and/or prepare extracted food based on input 115 and controlled by logic of controller 106. In embodiments, controller 106 may further prepare food by controlling receptacle mechanism 112 to separately place some items individually on tray 110, and to mix other items prior or after collection on tray 110.

Furthermore, controller 106 may include logic to convert complex requests received through the input interface 114 into individual food ingredients. For example, controller 106 may interpret a text recipe and identify specific food ingredients to be dispensed to a user. The determination of the amount of food ingredients to be extracted can be based on, for example, the content of the recipe. The recipe may further include instructions to prepare the items, such as cooking instructions, which are executed by controller 106 utilizing the components of apparatus 100.

In an example, controller 106 receives a recipe from a user as input (e.g., as part of input 115). Controller 106 processes the information in the recipe to determine a selection input, such as to identify bulk food containers containing ingredients identified in the recipe.

In embodiments, the controller 106 provides customization functionality to fulfill the request. Conditions may be defined by the user and identified in the user's request; provided by a third party such as the device owner; or predetermined as part of the functionality provided by controller 106. For example, the controller 106 may delay fulfilling a received order until the passing of a period of time.

In an example, controller 106 receives a wireless request from an application operating on a user's phone. The request includes information identifying the food for dispensation as well as information identifying who the request is for (i.e., the requesting user). The device detects that the user's request wishes to delay retrieving the food for a set period of time. Once the period of time has elapsed, the device retrieves the food and dispenses it for the user.

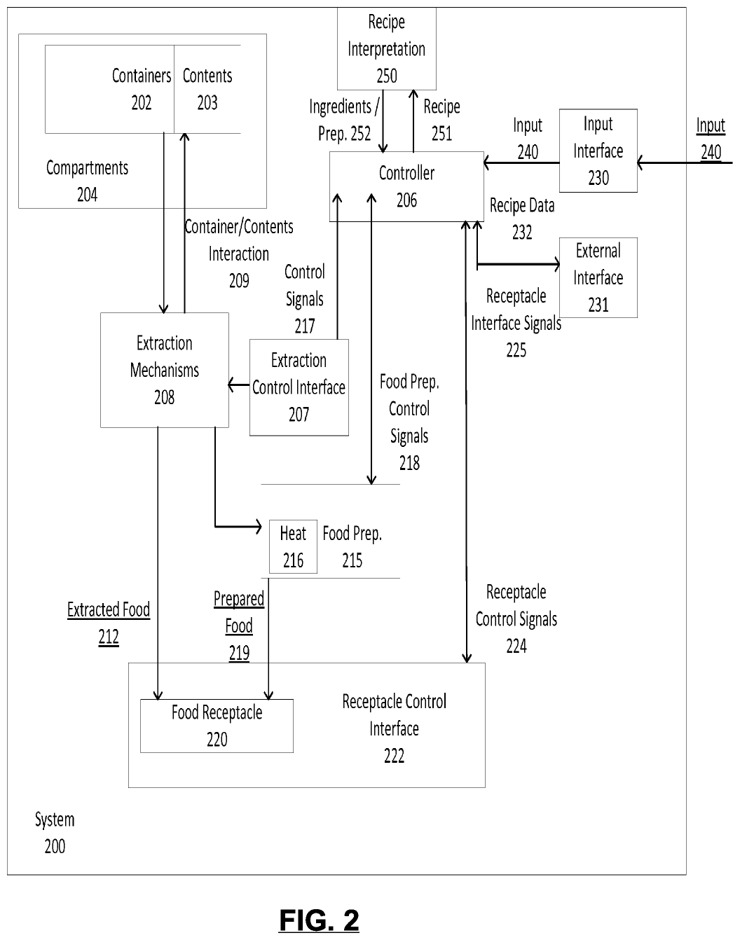

FIG. 2 is a logical representation of food packaging/preparation system, in accordance with one or more embodiments. In particular, a device as illustrated in FIG. 2 can optionally be implemented using, for example, structures and features such as shown with examples of FIG. 1. An example of FIG. 1 is described in which the generated output (tray 110) includes food ingredients which the user can prepare at one time, using a food preparation device. In an example of FIG. 2, variations or alternatively described to provide a cooked or prepared food output, using some of the components and functionality described with an example of FIG. 1. Examples as described recognize that components and functionality described with an apparatus of FIG. 1 can readily be substituted or put in use with an example of FIG. 2 and vice-versa. Accordingly, reference may be made to elements of FIG. 1, by way of illustration, in describing the components of FIG. 2. Moreover, an apparatus of FIG. 1 can include or otherwise be modified to include functionality described with an example of FIG. 2.

With reference to FIG. 2, system 200 includes a controller 206 which includes logic to control components illustrated in FIG. 2. Controller 206 provides control signals 217 via extraction control interface 207 to one or more extraction mechanisms 208. The extraction mechanisms 208 are moveable to interface (e.g., via interactions 209) with containers 202 (and their corresponding contents 203) held in compartments 204, and to combine with a receptacle control interface 222 to collect food ingredients in receptacle 220 (e.g., a single tray as described regarding FIG. 1). As described herein, embodiments utilize any number of containers and corresponding compartments.

In the embodiment of FIG. 2, input 240 is received over input interface 230 and provided to controller 206. In embodiments, input interface 230 receives manual input (e.g., via a keypad) utilized as a selection input and/or wireless input (e.g., from an application functioning on a user's phone). The input 240 identifies one or more food ingredients to be retrieved, as well as other pertinent information (e.g., amount of food; how food should be prepared).

As illustrated in FIG. 2, system 200 may optionally include one or more food preparation mechanisms 215, which further process or cook extracted food before that is collected in food receptacle 220. Food preparation mechanism 215 is controlled via food preparation control signals 218 from controller 206. System 200 further includes a receptacle control interface 222, to interact with food receptacle 220 (e.g., for delivery of extracted food 212 and prepared food 219 to a customer).

Food preparation mechanism 215 may include features, such as a heating element 216, which is controlled by controller 206 to prepare the food. Receptacle control interface 222 includes features to secure the food on or in food receptacle 220 (e.g., features to wrap or seal food) so that the food does not leave food receptacle 220. In one form, the food preparation mechanism 215 includes more simple logical elements, such as timer, temperature control and/or limited movement control to enable food preparation.

Receptacle control interface 222 interfaces with food receptacle 220 according to receptacle control signals 224. For example, after extracted food 212 or prepared food 219 has been moved to food receptacle 220, controller 206 may issue receptacle control signals 224 which cause the food receptacle 220 to be provided to the user. Furthermore, the receptacle control interface 222 provides receptacle interface signals 225, such as sensor signals, to controller 206. These signals may be interpreted by controller 206 to locate the food receptacle 220, to determine if the food receptacle has been delivered.

In embodiments, controller 206 includes or can access logic to receive and process recipes from users. In an example, controller 206 receives a recipe from a user via input interface 230 (e.g., as part of input 240). Controller 206 processes the information in the recipe to determine a selection input, such as to identify food ingredients. Data 232 pertaining to recipes, such as ingredient lists, may be retrieved via external interface 231 (e.g., via wireless retrieval of data as described below).

In an example illustrated in FIG. 2, recipe interpretation functionality 250 (e.g., a software module, or programming instructions executed by a processor) is utilized by controller 206 to interpret recipes. Recipe interpretation 250 enables controller 206 to convert a user's request for a recipe into instructions for food retrieval, such as the ingredients in the recipe. In an example illustrated by FIG. 2, a user provides an input 240 which includes a recipe 251. Recipe interpretation 250 interprets recipe 251 into information for what kinds of ingredients should be extracted from containers 202 and/or what preparation 252 should be performed via food preparation mechanisms 215. Controller 206 then converts this information into control signals 217, 218.

The recipe interpretation functionality 250 of FIG. 2 may be implemented as software operating on hardware. In embodiments, recipe information may be stored on the device (e.g., in a memory associated with controller 206). In another embodiment, recipe information is retrieved from an external source.

In an embodiment as illustrated by FIG. 2, input interface 230 and/or external interface 231 may include functionality for wireless communication (e.g., to wirelessly receive input 240) For example, the input interface 230 can enable communications under one or more of 802.11(s), 802.11(b), 802.11(g) or 802.11(n) (collectively “Wi-Fi”), or through cellular transmissions. As an addition or alternative, input interface 230 or external interface 231 can utilize a local wireless link, such as through a Bluetooth protocol to other devices (e.g., mobile devices operated by a user).

In an embodiment, input interface 230 wirelessly receives input via a dedicated website. The website may be associated with a system of user accounts through which users place orders for a particular food dispensing device associated with system 200. For example, a user who owns an account may log in and order food through the website, specifying that the food should be vended at a specific food dispensing device. When the user accesses the food dispensing device, the device retrieves the order from the website and dispenses the food.

In another embodiment of FIG. 2, input interface 230 includes functionality to directly receive a selection of one or more ingredients from a user. When the user accesses the device, the device accesses the order and dispenses the food ingredients.

As described regarding FIG. 1, input interface 230 may receive an amount input (e.g., via input 240) which further provides further detail about the one or more food ingredients. For example, input 240 may include an amount input specifying an amount of the food ingredients to be dispensed. Controller 206 controls the one or more food extraction mechanisms to extract the amount of each of the one or more food ingredients from the corresponding bulk food containers

While not illustrated in FIG. 2 for clarity, system 200 may include a payment feature through which the user provides payment. For example, the controller 206 may include functionality to request payment via credit cards, and a device associated with system 200 may include a physical credit card slot, which the user slides a credit card through. Alternatively or in addition system 200 may include multiple payment features, such as both a credit card slot and a physical feature to receive cash.

Extraction Mechanisms

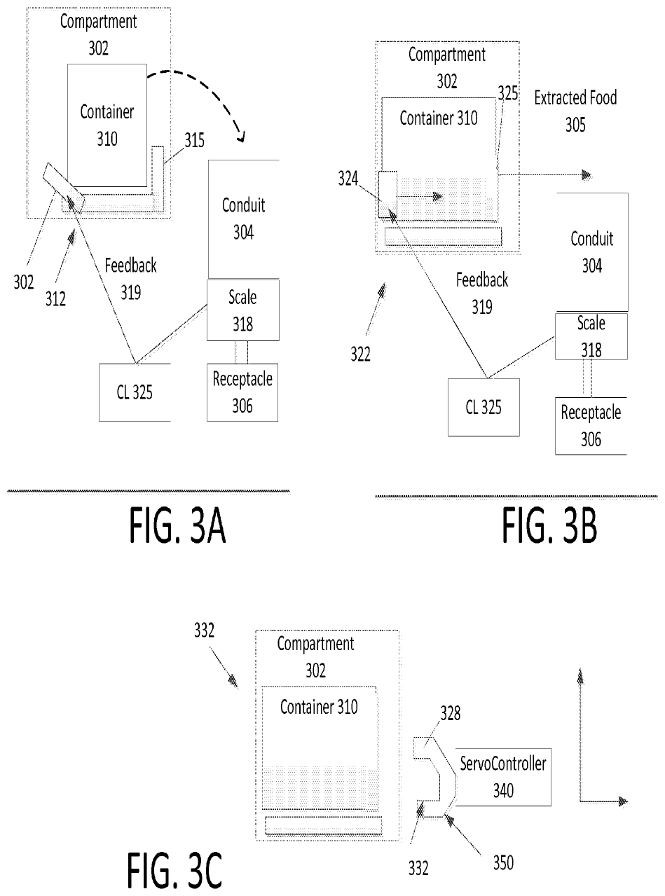

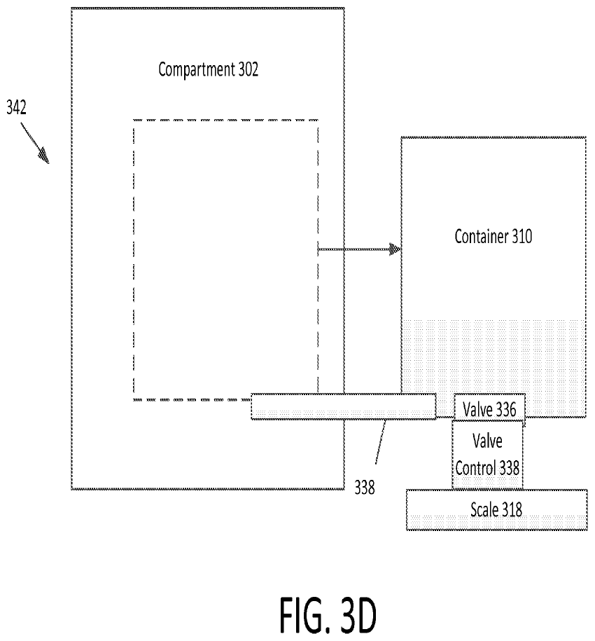

FIG. 3A-3D illustrate alternative variations of a food extraction mechanism, in accordance with one or more embodiments, In particular, extraction mechanisms illustrated in FIG. 3A-3D can optionally be implemented as part of, or with respect to, the apparatus or system as described with examples of FIG. 1 or FIG. 2. References are made below to elements of FIG. 1 and FIG. 2, by way of illustration, in describing the corresponding components.

FIG. 3A illustrates an extraction mechanism for mechanically tipping a food container, according to one embodiment. An extraction mechanism 300 as illustrated in FIG. 3A may be implemented in food dispensing devices or systems as discussed regarding FIG. 1 and FIG. 2, e.g., as the extraction mechanism 108 of FIG. 1. The food extraction mechanism 312 includes a lift 302 which rises at an angle under the container 310 to cause the container 310 to tip. A stop 315 can also be used to facilitate the tipping motion. Once tipped, the contents of container 310 can be received by a conduit 304. To control the amount of food dispensed, a scale 318 (or appropriate sensors) can be combined or integrated with the chute to measure food by weight. Control logic 325 of the food extraction mechanism 312 can receive the weight input as feedback 319 and then signal feedback 319 to the lift 302 to change the angle or rise of the lift, in order to increase or decrease food extraction as needed. When needed, the control logic can convert the weight of the extracted food to volume etc. to determine when the amount input is fulfilled. The lift 302 can be repositioned once the extraction is complete.

FIG. 3B illustrates an alternative extraction mechanism, according to another embodiment. An extraction mechanism 322 includes a mechanical pusher 324 which can be situated within the food container 310 to push food ingredients to an opening 325, where the food items can be received by the conduit 304 and scale 314. The control logic 325 can use the scale input to signal feedback for controlling the pusher 324.

FIG. 3C illustrates an extraction mechanism to selectively retrieve food ingredients from a container 320, according to an embodiment. In the example of FIG. 3C, food extraction mechanism 332 includes a robotic element in the form of a grabber 328 can be moved and controlled by servo controller 340 (which can be controlled by the control logic 106) within the confines of, for example, the apparatus 100, in order to interface with containers 310 and extract food items the bin food container 310. The grabber 328 can include an engagement end 332, shown as tongs, which can close or open to pick food. Other engagement ends can be utilized as well, such as shovel or vacuum ends. The specific engagement end in use may vary based on food type.

FIG. 3D illustrates an extraction mechanism which is gravity driven, according to one or more embodiments. A food extraction mechanism 342 includes a platform 338 that supports or couples to the container 310. The platform 338 can be motorized in order to move the container from a compartment to a valve interface 336. The container 310 can itself include an opening that aligns with the valve interface 336 (if not integrated). Alternatively, the valve interface 336 can be integrated or combined with the compartment. In other variations, the valve interface 336 is brought into engagement with the container 310.

The valve interface 336 can include, for example, male/female components, of which one may be provided to define the opening of the container 310. A valve control can receive the amount input from the controller 106 (FIG. 1), and then control size and/or duration of time until the output is measured to match the amount input. The scale 314 can weigh the extracted food collected at the container 310 and signal the valve control 338, which in turn can control either the size or duration of a valve opening of the valve interface 336.

With any of the examples described with FIG. 3A through FIG. 3D, the receptacle 306 can receive the extracted food, either directly or through additional mechanical manipulation of the food or receptacle.

Methodology

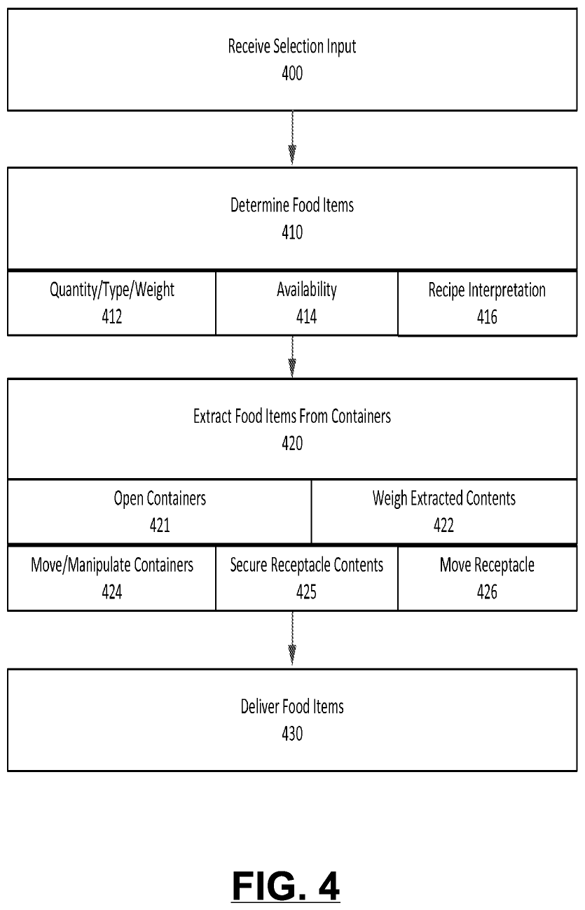

FIG. 4 illustrates a method to package food ingredients, according to an embodiment. In describing an example of FIG. 4, reference may be made to other examples, such as elements described with FIG. 1, 2, or 3A-3D. Reference is made to elements of other examples for purpose of illustrating suitable elements or components for performing a step or sub-step being described.

With reference to the devices of FIGS. 1, and 2, steps of FIG. 4 (e.g., food ingredient extraction (420) and delivery (430)) may be performed, at least in part, by controlling an automated robotic set of components in extracting the one or more food ingredients from corresponding bulk food containers.

A selection input is received by a food dispensing device (e.g., as described with regards to FIGS. 1 and 2) from a customer, which requests one or more food ingredients for dispensation from stored containers (400). The input can be received wirelessly or from an input device (e.g., a keypad) coupled to a processor of the food dispensing device. The input can specify specific ingredients, quantity or volume of ingredients, aspects of the ingredients (e.g., freshness), or other desirable desired features. In an embodiment, the input specifies a recipe which is includes a set of ingredients.

Based on the input, a determination is made as to which food ingredients are to be dispensed to the customer (410). The determination include identifying quantities, types or weights of food ingredients which are desired by the customer (412), making a confirmation that the requested ingredients are available in the food dispensing device for the customer (414), and/or identifying and interpreting the input as a recipe (416). Furthermore the determination may include determining one or more food preparation steps which are necessary to provide the desired food ingredients.

In an example where the input includes a recipe, the recipe interpretation (416) may include recognizing the input as a recipe, determining one or more constituent food ingredients, and determining one or more cooking steps which are needed to prepare the food ingredients for use in the recipe.

Food ingredients are then extracted from containers stored within the food dispensation device into a receptacle (420). Food can be extracted by, for example, interfacing with bulk food bins to extract an amount by weight which corresponds to the amount input. Accordingly, in some variations, the food extraction can include additional mechanically controlled operations, including opening packaging of some food items (e.g., plastic bags) in containers (421), weighing extracted contents (422), moving or manipulating containers or their contents (423), securing the contents of the receptacle (424) (for example, sealing or wrapping the receptacle to avoid spillage), or moving the receptacle in which food ingredients are placed (425). The food ingredients are then delivered (430). For example the food ingredients may be dispensed onto a receptacle to be provided to the customer.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A food dispensing and packaging apparatus comprising:
an input interface to receive a selection input that identifies one or more food ingredients;
a plurality of compartments, each compartment positioned to hold a corresponding bulk food container, and each bulk food container holding a corresponding food ingredient;
one or more food extraction mechanisms which are moveable to interface with the corresponding bulk food containers of each of the plurality of compartments;
a controller to process the selection input from the input interface in order to identify one or more bulk food containers which hold the one or more identified food ingredients, and to control at least one food extraction mechanism to extract the identified one or more food ingredients from the corresponding one or more bulk food containers held in one or more of the plurality of compartments which are identified by the selection input; and
a receptacle mechanism, wherein the at least one food extraction mechanism and the receptacle mechanism combine to collect the extracted identified one or more food ingredients into a single receptacle.
